(19) United States
(12) Patent Application Publication
(10) Pub. No.: US 2022/0040760 A1
(43) Pub. Date: Feb. 10, 2022

(54) SINTERING APPARATUS FOR FIELD-ASSISTED SINTERING

(71) Applicant: Dr. Fritsch Sondermaschinen GmbH, Fellbach (DE)

(72) Inventors: Gerhard WEBER, Winnenden (DE); Karl WEBER, Winnenden (DE); Ute Wilkinson, Winnenden (DE)

(21) Appl. No.: 17/392,708

(22) Filed: Aug. 3, 2021

(30) Foreign Application Priority Data
Aug. 7, 2020 (DE) 102020210034.9

(51) Int. Cl. B22F 3/14; B22F 3/105; B22F 3/03

(52) U.S. Cl. CPC B22F 3/14; B22F 3/03; B22F 3/105

(57) ABSTRACT

Sintering apparatus, having an electrically conductive die with a receiving space provided for receiving a sintering material to be sintered, a first adjusting device and a mold punch adjustably moved by the first adjusting device into a pressing position, in which, for the purpose of the mechanical pressurization of the sintering material with a first compressive force, the at mold punch is dipped axially into the receiving space. A resistance heating device is configured to heat the die by applying an electric current to the die. Assigned to the resistance heating device are a second adjusting device and a contact punch be adjustably moved by the second adjusting device into a contact position, in which, for applying an electric current to the die, the contact punch is pressed against an outer surface of the die with a second compressive force.

### CROSS-REFERENCE TO RELATED APPLICATION

This claims priority from German Application No. 10 2020 210 034.9, filed Aug. 7, 2020, the disclosure of which is hereby incorporated by reference in its entirety.

### TECHNICAL FIELD

The invention relates to a sintering apparatus for field-assisted sintering, having at least one electrically conductive die with a receiving space, which is provided for receiving a sintering material to be sintered, in particular in the form of a green compact, a first adjusting device and at least one mold punch, which can be adjustably moved by means of the first adjusting device along a first adjustment axis relative to the receiving space into a pressing position, in which, for the purpose of the mechanical pressurization of the sintering material with a first compressive force, the at least one mold punch is dipped axially into the receiving space, and having a resistance heating device which is configured to heat the die by means of applying an electric current to said die.

### BACKGROUND AND SUMMARY

A sintering apparatus of this type is known from WO 2017/177995 A1 and is provided for field-assisted sintering. What is known as field-assisted sintering is also known under the abbreviations FAST (field-assisted sintering technology) and SPS (spark plasma sintering). The known sintering apparatus has an electrically conductive die in the shape of an annular mold, into which the sintering material to be sintered is introduced, and two mold punches which can be dipped in opposite directions axially into the annular mold. Additionally provided is a resistance heating device with a pulsed direct current source and two electrodes. The electrodes are supported on rear sides of the mold punches in a compressive-force-transferring and electrically conductive manner. In order to apply a compressive force to the sintering material, an adjusting device acts on the rear side of the electrodes and moves them toward one another along an adjustment axis together with the mold punches. At the same time, in order to heat the die a pulsed direct current is conducted via the electrodes into the mold punches and from there into the die. As a consequence of the electrical resistance of the die, it is heated up and as a result the application of heat to the sintering material that is necessary for sintering is brought about.

It is an object of the invention to provide a sintering apparatus of the type mentioned at the outset that has improved properties over the prior art and allows, in particular, an improved pressurization of and application of heat to the sintering material.

Said object is achieved in that assigned to the resistance heating device are a second adjusting device and at least one contact punch, which can be adjustably moved by means of the second adjusting device along a second adjustment axis relative to the die into a contact position, in which, for the purpose of applying an electric current to the die, the at least one contact punch is pressed against an outer surface of the die with a second compressive force. The solution according to the invention makes it possible for the mechanical pressurization of the sintering material to be effected independently of the application of an electric current to the die, and vice versa. This is because, by contrast to conventional sintering apparatuses for field-assisted sintering, current is not applied to the die via the at least one mold punch that is provided for mechanical pressurization at the same time, for instance. Instead, the application of current is effected according to the invention via the at least one contact punch and the pressurization is effected via the at least one mold punch. In this respect, for simplicity it is also possible to refer to a separate and/or independent flow of force and current. The solution according to the invention makes it possible to configure the at least one contact punch in a targeted manner in terms of the application of electric current and independently of requirements of the mechanical pressurization. At the same time, the at least one mold punch can be configured in a targeted manner in terms of the mechanical pressurization and independently of requirements of the application of electric current. The at least one mold punch and the at least one contact punch can, for example, advantageously be manufactured from different materials and/or have different dimensions—in particular different cross sections for the mechanical transfer of force or electrical energy and/or different contact surfaces for making contact with the sintering material or the outer surface of the die. In this respect, it is not imperatively necessary according to the invention that the at least one mold punch is manufactured from an electrically conductive material. Instead, a particularly pressure-stable material, in particular ceramic or the like, can advantageously be used. At the same time, it is not imperatively necessary according to the invention that the at least one contact punch is manufactured from a particularly pressure-stable material. Instead, a particularly conductive material can advantageously be used. It is also provided according to the invention that the at least one mold punch can be adjustably moved by means of the first adjusting device, and that the at least one contact punch can be adjustably moved by means of the second adjusting device. The first adjusting device brings about the first compressive force for applying a compressive force to the sintering material. The second adjusting device brings about the second compressive force for pressing the at least one contact punch against the outer surface of the die. In this way, the second compressive force can be set in a targeted manner in terms of an electrical contact resistance between the at least one contact punch and the outer surface and independently of the pressurization of the sintering material to be achieved. At the same time, the first compressive force can be set in a targeted manner in terms of the application of compressive force to the sintering material and independently of the contact resistance to be achieved between the at least one contact punch and the outer surface. The solution according to the invention offers particular advantages if the at least one mold punch has a small cross-sectional area and/or mass compared to the die. In the case of sintering apparatuses from the prior art, with these stipulations and under certain conditions, it is not possible to obtain a sufficient application of current and therefore heat, since the cross section and/or the mass of the mold punch is too low in relation to the die for this purpose. In the case of the solution according to the invention, this does not play a role, since the application of current and therefore heat takes place via the at least one contact punch and independently of the at least one mold punch. The solution according to the invention additionally offers particular advantages if only a comparatively low application of compressive force to the sintering material is required, for example because said sintering material has a liquid phase. In the case of sintering apparatuses from the prior art, with these stipulations and under certain conditions, it is not possible to effect an optimal application of current and therefore also heat, since the electrical contact resistance is too high because of the comparatively low pressing force. The solution according to the invention ensures instead that, even in the case of a comparatively low first compressive force for the application of compressive force, a sufficiently low electrical contact resistance can be obtained. This is because the second compressive force, which is significant for the achievable electrical contact resistance, is applied by means of the at least one contact punch and independently of the at least one mold punch. The die can also be referred to as a mold or sintering mold. The first compressive force can also be referred to as pressing force. The second compressive force can also be referred to as contact force. The first adjustment axis and the second adjustment axis may be oriented in particular parallel, coaxially or perpendicularly to one another. In one configuration of the invention, a plurality of mold punches and/or a plurality of contact punches may be provided. The first compressive force and/or the second compressive force is preferably created hydraulically. Accordingly, the first adjusting device and/or the second adjusting device is preferably a hydraulic adjusting device, pneumatic adjusting device or electromotive adjusting device. In this respect, in order to apply the first compressive force and/or the second compressive force, at least one respective hydraulic cylinder, pneumatic cylinder and/or motor-driven spindle may be provided. The sintering apparatus according to the invention is configured for field-assisted sintering, wherein the field-assisted sintering can also be referred to by the abbreviations FAST (field-assisted sintering technology) and/or SPS (spark plasma sintering).

In one configuration of the invention, a regulating device is provided, which is configured to regulate the first compressive force to a first value and to regulate the second compressive force to a second value. As a result, on the one hand a particularly precise application of compressive force to the sintering material can be obtained. On the other hand, the regulating of the second compressive force makes it possible to influence and regulate the electrical contact resistance which arises between the at least one contact punch and the outer surface of the die in a targeted manner. This makes it possible to obtain a further improved application of current and therefore heat. As an alternative or in addition, the regulating device may be configured to control the first compressive force and the second compressive force and in this respect may be designed as a simple control device.

In a further configuration of the invention, the first adjustment axis and the second adjustment axis are oriented parallel and/or coaxially to one another, wherein the at least one contact punch is pressed against a bottom or top end face of the die in the contact position. In this way, in particular a structurally simple construction of the sintering apparatus is obtained. The first compressive force and the second compressive force are oriented parallel and/or coaxially to one another in a manner corresponding to the adjustment axes. The bottom or top end face of the die is preferably oriented perpendicularly to the second compressive force and thus the second adjustment axis.

In a further configuration of the invention, the at least one contact punch has an annular form with a through-opening, through which the first adjustment axis is longitudinally extended, in particular coaxially. In this way, a further simplified structure of the sintering apparatus can be obtained. The annular form of the at least one contact punch is preferably a circular-cylindrical form. The through-opening is preferably a circular-cylindrical through-opening. An axial direction of the annular form and/or of the through-opening is preferably oriented coaxially to the second adjustment axis. It is preferably the case that the mold punch and/or the first adjusting device is longitudinally extended through the through-opening at least in certain portions in each case. This occurs in the pressing position in any event. In this configuration of the invention, the die preferably has an annular form, in particular a circular-cylindrical form.

In a further configuration of the invention, the first adjustment axis and the second adjustment axis are oriented perpendicularly to one another, wherein the at least one contact punch is pressed against a lateral outer shell surface of the die in the contact position. The outer shell surface is oriented perpendicularly to the second adjustment axis and/or second compressive force. In this configuration of the invention, the first adjustment axis is oriented vertically and the second adjustment axis is oriented horizontally, or vice versa. Such an orientation of the adjustment axes can offer structural advantages. In particular, an available structural space can be utilized in an improved way.

In a further configuration of the invention, the die has a cuboidal form, wherein the outer shell surfaces are oriented perpendicularly to the second adjustment axis and parallel to the first adjustment axis. Such a cuboidal form of the die is advantageous in particular when the die is configured as a multiple-cavity mold with a plurality of receiving spaces. Such multiple-cavity molds offer particular advantages during the industrial manufacture of comparatively “small” sintered parts, such as grinding points or burs for dental treatment, for example. The cuboidal form and corresponding orientation of the outer shell surfaces makes it possible—in particular compared to a cylindrical form of the die—to obtain a comparatively relatively large contact surface between the at least one contact punch and the outer shell surface. Moreover, an available structural space can be utilized in an improved way.

In a further configuration of the invention, the die is configured as a multiple-cavity mold with a plurality of receiving spaces. Such a configuration is particularly advantageous in particular in combination with the preceding configuration of the invention. At least one mold punch is assigned to each of the plurality of receiving spaces, with the result that a plurality of mold punches is accordingly provided.

In a further configuration of the invention, the at least one mold punch is electrically non-conductive, wherein the at least one mold punch is manufactured from an electrically insulating material and/or has an electrically insulating coating. For this purpose, the at least one mold punch may in particular be manufactured from ceramic or have a ceramic coating. Sintering apparatuses known from the prior art for field-assisted sintering usually imperatively presuppose an electrically conductive configuration of the mold punch or the mold punches. This configuration of the invention circumvents the restricted selection of materials that is usually associated with this.

In a further configuration of the invention, the at least one mold punch is manufactured from metal. Such a selection of material for the mold punch is in particular, but not exclusively, advantageous in conjunction with a die configured as a multiple-cavity mold for the manufacture of “small” sintered parts. Since the at least one mold punch is manufactured from metal, it has a comparatively low electrical resistance, this being disadvantageous for performing a routine field-assisted sintering process on account of the comparatively low degree of heating caused by the resistance that is associated with this. This disadvantage is circumvented by the separation according to the invention between the application of current and application of compressive force, since the application of current is effected via the at least one contact punch and thus separately from the at least one metallic mold punch.

In a further configuration of the invention, the first adjusting device acts by way of an insulating element, which is electrically and/or thermally insulating, on the at least one mold punch. Expressed in other words, the first adjusting device is electrically and/or thermally insulated with respect to the at least one mold punch by means of the insulating element. This counteracts an undesired dissipation of current and/or heat by way of the first adjusting device. This makes it possible to obtain a further improved application of current and therefore heat to the sintering material. The insulating element is preferably manufactured from a ceramic material.

In a further configuration of the invention, a first mold punch and a second mold punch are provided which can be adjustably moved by means of the first adjusting device along the first adjustment axis in opposite directions relative to one another, and which in the pressing position are dipped into the receiving space axially in opposite directions relative to one another. In this configuration, the receiving space is in the form of a through-opening which extends axially through the die and has mutually opposite face openings. The two mold punches respectively project axially into one of the face openings in the pressing position. In order to apply the first compressive force, the first mold punch and the second mold punch are moved relatively toward one another along the first adjustment axis. For this purpose, the first mold punch and/or the second mold punch can be displaced in an adjustably movable manner by means of the first adjusting device. Expressed in other words, the two mold punches or only one of the two mold punches can be displaced in an adjustably movable manner.

In a further configuration of the invention, a first contact punch and a second contact punch are provided which can be adjustably moved by means of the second adjusting device along the second adjustment axis in opposite directions relative to one another, and which in the contact position are pressed against mutually opposite outer surfaces of the die. Depending on the orientation of the second adjustment axis, the opposite outer surfaces may be axially opposite end faces of the die or laterally opposite outer shell surfaces of the die. In order to apply the second compressive force, the first contact punch and the second contact punch are moved relatively toward one another along the second adjustment axis. For this purpose, the first contact punch and/or the second contact punch can be displaced in an adjustably movable manner by means of the second adjusting device. Expressed in other words, the two contact punches or only one of the two contact punches can be displaced in an adjustably movable manner.

In a further configuration of the invention, the resistance heating device is configured to apply an alternating current and/or a direct current, in particular a pulsed direct current, to the die. Depending on the specific usage situation and/or sintering material to be sintered, an application of alternating current or direct current, in particular pulsed direct current, may offer particular advantages. This configuration of the invention thus allows a particularly flexible use of the sintering device.

Further advantages and features of the invention will emerge from the claims and from the following description of preferred exemplary embodiments of the invention, which are presented on the basis of the figures.

### BRIEF DESCRIPTION OF THE DRAWINGS

FIG. 1 shows a schematically greatly simplified illustration of one embodiment of a sintering apparatus according to the invention that is provided for field-assisted sintering,

FIG. 2 shows a schematic and partially sectional illustration of a detail of a further embodiment of a sintering apparatus according to the invention, and

FIG. 3 shows a schematic and partially sectional illustration of a detail of a further embodiment of a sintering apparatus according to the invention.

### DETAILED DESCRIPTION

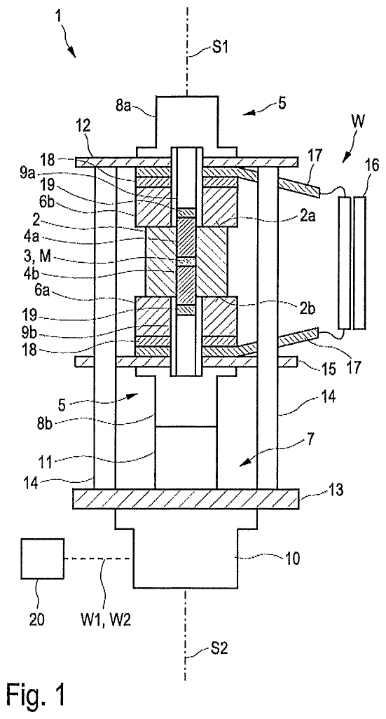

According to FIG. 1, a sintering apparatus 1 is configured for field-assisted sintering and thus for carrying out a FAST or SPS process.

The sintering apparatus 1 has a die 2, which can also be referred to as a mold or sintering mold. The die 2 has a receiving space 3, which is provided for receiving a sintering material M to be sintered. In this respect, the die 2 is manufactured from an electrically conductive material, in the present case graphite being selected as the material. In the embodiment shown, the sintering material M in the form of a green compact, which can also be referred to as a powder part, compacted body or green body, is received in the receiving space 3.

In order to perform field-assisted sintering of the sintering material M, said sintering material is on the one hand mechanically pressurized. On the other hand, the sintering material M is heated at the same time and in this respect is subjected to heat.

In order to pressurize the sintering material M, the sintering apparatus 1 has at least one mold punch 4a and a first adjusting device 5. The mold punch 4a can be adjustably moved by means of the first adjusting device 5 along a first adjustment axis S1 relative to the die 2 and thus also to the receiving space 3 between different positions. In this respect, on the basis of FIG. 1, a pressing position of the mold punch 4a is shown in which, for the purpose of the mechanical pressurization of the sintering material M, said mold punch is dipped in the receiving space 3 in an axial direction along the first adjustment axis S1, and in this way a first compressive force (not denoted in more detail) which acts axially along the first adjustment axis S1 is transferred to the sintering material M. The first compressive force can also be referred to as pressing force.

In order to apply heat to the sintering material M, the sintering apparatus 1 has a resistance heating device W. At least one contact punch 6a and a second adjusting device 7 is assigned to the resistance heating device W. In this respect, the contact punch 6a can be adjustably moved by means of the second adjusting device 7 along a second adjustment axis S2 relative to the die 2 between different positions. On the basis of FIG. 1, the contact punch 6a is shown in a contact position. In this position, the contact punch 6a is pressed against an outer surface (not denoted in any more detail) of the die 2 for the purpose of applying electric current to the die. In this respect, a second compressive force acts, which can also be referred to as contact force.

Numerous advantages are obtained by virtue of the structural separation described above between the pressurization on the one hand and on the other hand the application of current and therefore heat.

It is possible in particular to select and/or set the pressing and the contact force independently of one another. The same applies for the structural configuration of the effective cross sections and/or contact surfaces of the mold punch 4a and the contact punch 6a. Expressed in other words, the dimensions of the contact punch 6a that are effective for the purpose of applying electric current are structurally independent of the dimensions of the mold punch 4a that are effective for the pressurization. This is advantageous in particular when a mold punch which is small compared to the dimensions of the die—for the purpose of sintering “small” sintered parts—is required.

Furthermore, as a consequence of the construction according to the invention of the sintering apparatus 1, it is not imperatively necessary for the mold punch 4a to be electrically conductive. Instead, it is possible to use a particularly pressure-stable material, for example. Vice versa, it is not imperatively necessary for the contact punch 6a to be particularly pressure-stable, and therefore a particularly conductive material can be used in terms of the most optimum possible application of current.

Further spatial-physical features and functional features of the embodiment shown on the basis of FIG. 1 will be explained in detail below. These features are advantageous, but not to be considered essential and/or imperatively necessary in terms of the invention.

In the embodiment shown on the basis of FIG. 1, the first adjustment axis S1 and the second adjustment axis S2 are oriented coaxially.

In the present case, in addition to the mold punch 4a, which can also be referred to as first mold punch, the sintering apparatus 1 has a further mold punch 4b. Said further mold punch can also be referred to as second mold punch. The first mold punch 4a and the second mold punch 4b can be adjustably moved along the first adjustment axis S1 in opposite directions relative to one another. In the pressing position, the two mold punches 4a, 4b are dipped axially in an opposed manner in the receiving space 3. In the embodiment shown, said receiving space is configured as a passage bore which extends axially through the die 2. The two mold punches 4a, 4b also can be moved relative to one another by means of the first adjusting device 5.

In the embodiment shown, the first adjusting device 5 has an upper pressing cylinder 8a, 9a and a lower pressing cylinder 8b, 9b. The upper pressing cylinder 8a, 9a acts on the first mold punch 4a. The lower pressing cylinder 8b, 9b acts on the second mold punch 4b. The upper pressing cylinder 8a, 9a has a main body 8a and a movable pressing punch 9a. The same applies analogously for the lower pressing cylinder 8b, 9b.

In the embodiment shown, in addition to the contact punch 6a, which can also be referred to as first contact punch, the sintering apparatus 1 also has a further contact punch 6b. The latter can also be referred to as second contact punch. In the contact position shown (FIG. 1), the two contact punches 6a, 6b are pressed against mutually opposite end faces 2a, 2b of the die 2. In order to apply the second compressive force and for the purpose of making electrical contact, the two contact punches 6a, 6b can be moved relative to one another by means of the second adjusting device 7 along the second adjustment axis S2. In the present case, the second adjusting device 7 is configured as a further pressing cylinder, is referred to as the table cylinder 10, 11, and has a main body 10 and a table punch 11 which can be moved relative to said main body.

In the embodiment shown, the upper pressing cylinder 8a, 9a, the lower pressing cylinder 8b, 9b and the table cylinder 10, 11 are respectively configured as a hydraulic cylinder.

In one embodiment (not shown), the pressing cylinders and the table cylinder are configured as pneumatic cylinders. In a further embodiment (not shown), it is instead the case that electromotively driven spherical spindles are provided for applying the adjusting movements along the adjustment axes.

In the embodiment shown, the sintering apparatus 1 also has a frame arrangement 12, 13, 14, 15. Said frame arrangement has a positionally fixed upper plate 12, a positionally fixed lower plate 13, a plurality of guiding columns 14 extending longitudinally between the positionally fixed plates 12, 13, and a movable plate 15 which is guided movably on the guiding columns 14. The upper plate 12 can also be referred to as crosshead. The lower plate 13 can also be referred to as base plate. The movable plate 15 can also be referred to as press table.

In the embodiment shown, the table cylinder 10, 11 and the lower pressing cylinder 8b, 9b are connected kinematically in series, as it were. For this purpose, the lower pressing cylinder 8b, 9b is supported on the table punch 11 of the table cylinder 10, 11. The main body 10 of the table cylinder 10, 11 is connected fixedly to the base plate 13. By contrast, the main body 8b of the lower pressing cylinder 8b, 9b is connected fixedly to the press table 15. The main body 8a of the upper pressing cylinder 8a, 9a is connected fixedly to the crosshead 12.

The resistance heating device W is configured to apply an alternating current and/or a direct current, in particular a pulsed direct current, to the die 2 and has a transformer 16, connecting elements 17, which are designed as copper connections in the present case, and electrodes 18. Said electrodes are designed as brass electrodes. Proceeding from the transformer 16, current can be applied to the die 2 via the connecting elements 17, the electrodes 18 and from there via the contact punches 6a, 6b.

In the embodiment shown, the two contact punches 6a, 6b have an annular form with a respective through-opening (not denoted in more detail), through which the first adjustment axis S1 of the first adjusting device 5 is extended. The upper pressing punch 9a and/or the first mold punch 4a project axially into the through-opening in the second contact punch 6b. The lower pressing punch 9b and/or the second mold punch 4b projects into the through-opening in the first contact punch 6a.

The electrodes 18 arranged on the rear side of the contact punches 6a, 6b so as to make electrical contact are accordingly of annular configuration with respective through-openings (not denoted in more detail) for the pressing punches 9a, 9b. It is also the case that the connecting elements 17 have such a respective annular configuration in their region of contact with the electrodes 18.

The contact punches 6a, 6b are arranged along the second adjustment axis S2 between the crosshead 12 and the press table 15 and supported at the top on the crosshead 12 and at the bottom on the press table 15 by way of the respective electrode 18 and the respective connecting element 17.

In order to press the contact punches 6a, 6b, the press table 15 is displaced along the second adjustment axis S2 in the direction of the crosshead 12 and thus—with respect to the plane of the drawing of FIG. 1—upwardly. This is effected under the action of the table cylinder 10, 11, the table punch 11 of which here raises the main body 8b, supported on the bottom of the press table 15, of the lower pressing cylinder 8b, 9b. As soon as the contact punches 6a, 6b assume the contact position and the required second compressive force is achieved, the required application of compressive force to the sintering material M can be effected by way of corresponding adjusting movements of the upper pressing punch 9a and the lower pressing punch 9b.

In the embodiment shown, the mold punches 4a, 4b are insulated from the respective pressing punch 9a and 9b, respectively, by means of a respective insulating element 19. In the present case, the insulating elements 19 ensure thermal and electrical insulation and are manufactured from a ceramic material for this purpose.

Moreover, the mold punches 4a, 4b are respectively electrically non-conductive and are manufactured from an electrically insulating material, for example ceramic, for this purpose. In one embodiment (not shown), it is instead the case that only an electrically insulating coating of the mold punches may be provided.

In the present case, the sintering apparatus 1 also has a regulating device 20. The regulating device 20 is configured to regulate the first compressive force to a first value W1 and to regulate the second compressive force to a second value W2. The regulating device 20 is illustrated in a schematically greatly simplified manner. The connection, which can be seen on the basis of FIG. 1 as dashed lines, between the regulating device 20 and the rest of the components of the sintering apparatus 1 schematically constitutes an operative connection in a regulating system to at least the first adjusting device 5 and the second adjusting device 7. The regulating device 20 makes it possible to set the pressing force and the contact force separately from one another and to adjust said forces to the predefined values W1, W2. This is advantageous in particular in conjunction with the kinematic series connection described above between the table cylinder 10, 11 and the lower pressing cylinder 8b, 9b.

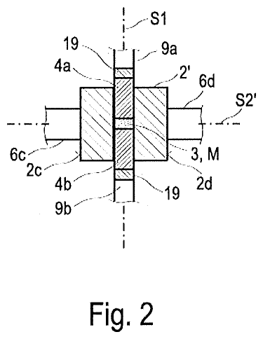

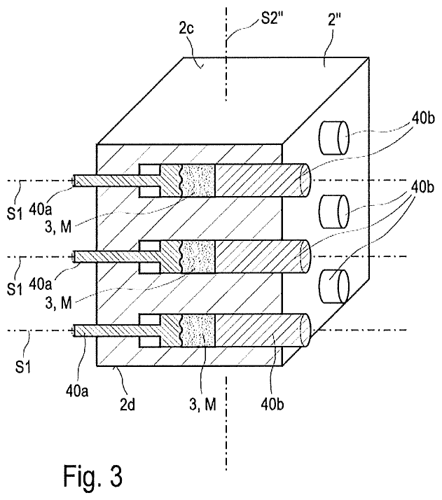

FIGS. 2 and 3 show illustrations of a detail of further embodiments of sintering apparatuses according to the invention. In order to avoid repetitions, only significant differences in the embodiments according to FIGS. 2 and 3 over the embodiment according to FIG. 1 will be discussed below. In this respect, identical components are provided with identical reference signs and are not explained separately.

A significant difference of the embodiment according to FIG. 2 is that a second adjustment axis S2′, oriented perpendicularly to the first adjustment axis S1, is provided. Accordingly, in the contact position shown the contact punches 6c, 6d are pressed against lateral outer shell surfaces 2c, 2d of the die 2′. The outer shell surfaces 2c, 2d are oriented perpendicularly to the second adjustment axis S2′. In order to allow a contact of the contact punches 6c, 6d which is as areal as possible, the outer shell surfaces 2c, 2d are oriented in a parallel plane to one another, the die 2′ having a rectangular, in particular square, outer contour. This differs from the circular-cylindrical configuration of the die 2 according to FIG. 1.

A significant difference of the embodiment according to FIG. 3 is that the die 2″ is configured as a multiple-cavity mold with a plurality of receiving spaces 3. The receiving spaces 3 are provided respectively for receiving a sintering material M to be sintered, with the result that the present configuration allows a plurality of sintered parts to be sintered at the same time. Two mold punches 40a, 40b which can be adjustably moved in opposite directions along a first adjustment axis S1 are respectively assigned to each receiving space 3. In this respect, the mold punches 40a are respectively manufactured from metal. This is advantageous in particular in terms of the configuration, which is comparatively thin in certain portions, of the mold punches 40a that can be seen on the basis of FIG. 3. The contact force (not denoted in more detail) is applied along the second adjustment axis S2″ to outer shell surfaces 2c, 2d of the die 2″. The second adjustment axis S2″ is oriented perpendicularly to the first adjustment axes S1 of the mold punches 40a, 40b arranged in pairs. Moreover, the die 2″ has—similarly to the die 2′ according to FIG. 2—a cuboidal form, wherein the outer shell surfaces 2c, 2d are oriented perpendicularly to the second adjustment axis S2″ and parallel to the first adjustment axes S1.

1. A sintering apparatus for field-assisted sintering, having
at least one electrically conductive die with a receiving space, which is provided for receiving a sintering material to be sintered, in particular in the form of a green compact,
a first adjusting device and at least one mold punch, which can be adjustably moved by the first adjusting device along a first adjustment axis relative to the receiving space into a pressing position, in which, for the purpose of the mechanical pressurization of the sintering material with a first compressive force, the at least one mold punch is dipped axially into the receiving space
and having a resistance heating device which is configured to heat the die by applying an electric current to said die,
wherein assigned to the resistance heating device are a second adjusting device and at least one contact punch, which can be adjustably moved by the second adjusting device along a second adjustment axis relative to the die into a contact position, in which, for the purpose of applying an electric current to the die, the at least one contact punch is pressed against an outer surface of the die with a second compressive force.

2. The sintering apparatus according to claim 1, wherein a regulating device is provided, which is configured to regulate the first compressive force to a first value and to regulate the second compressive force to a second value.

3. The sintering apparatus according to claim 1, wherein the first adjustment axis and the second adjustment axis are oriented parallel and/or coaxially to one another, wherein the at least one contact punch is pressed against a bottom or top end face of the die in the contact position.

4. The sintering apparatus according to claim 3, wherein the at least one contact punch has an annular form with a through-opening, through which the first adjustment axis is longitudinally extended, in particular coaxially.

5. The sintering apparatus according to claim 1, wherein the first adjustment axis and the second adjustment axis are oriented perpendicularly to one another, wherein the at least one contact punch is pressed against a lateral outer shell surface of the die in the contact position.

6. The sintering apparatus according to claim 5, wherein the die has a cuboidal form, and the outer shell surfaces are oriented perpendicularly to the second adjustment axis and parallel to the first adjustment axis.

7. The sintering apparatus according to claim 5, wherein the die is configured as a multiple-cavity mold with a plurality of receiving spaces.

8. The sintering apparatus according to claim 1, wherein the at least one mold punch is electrically non-conductive, wherein the at least one mold punch is manufactured from an electrically insulating material and/or has an electrically insulating coating.

9. The sintering apparatus according to claim 1, wherein the at least one mold punch is manufactured from metal.

10. The sintering apparatus according to claim 1, wherein the first adjusting device acts by way of an insulating element, which is electrically and/or thermally insulating, on the at least one mold punch.

11. The sintering apparatus according to claim 1, wherein a first mold punch and a second mold punch are provided which can be adjustably moved by the first adjusting device along the first adjustment axis in opposite directions relative to one another, and which in the pressing position are dipped in the receiving space axially in opposite directions relative to one another.

12. The sintering apparatus according to claim 1, wherein a first contact punch and a second contact punch are provided which can be adjustably moved by the second adjusting device along the second adjustment axis in opposite directions relative to one another, and which in the contact position are pressed against mutually opposite outer surfaces of the die.

13. The sintering apparatus according to claim 1, wherein the resistance heating device is configured to apply an alternating current and/or a direct current, in particular a pulsed direct current, to the die.
